(19) United States
(12) Patent Application Publication
(10) Pub. No.: US 2025/0191274 A1
(43) Pub. Date: Jun. 12, 2025

(54) APPARATUS AND METHOD FOR TRANSFERRING STYLE OF BUILDING MODEL TEXTURE

(71) Applicant: ELECTRONICS AND TELECOMMUNICATIONS RESEARCH INSTITUTE, Daejeon (KR)

(72) Inventors: Hyeon-Joong WI, Daejeon (KR); Kang-Woo LEE, Daejeon (KR); In-Sung JANG, Daejeon (KR); In-Hak JOO, Daejeon (KR)

(21) Appl. No.: 18/809,719

(22) Filed: Aug. 20, 2024

(30) Foreign Application Priority Data
Nov. 27, 2023 (KR) 10-2023-0167197
May 31, 2024 (KR) 10-2024-0071541

(51) Int. Cl. G06T 15/04

(52) U.S. Cl. CPC G06T 15/04; G06T 2210/12

(57) ABSTRACT

Disclosed herein is an apparatus and method for transferring a building model texture style. The apparatus receives 3D building model geometry data and 3D building model texture information, converts the same into a building model image, performs preprocessing for setting the area to which style transfer is to be applied by generating a mask image through segmentation into a window and a wall of the building model image and generating a floor grid area based on the segmentation into the window and the wall, performs style transfer of the building model image by applying a predefined user-style image to areas corresponding to the mask image and the floor grid area, and converts the building model image, the style of which is transferred, into 3D building model texture information.

### CROSS REFERENCE TO RELATED APPLICATIONS

This application claims the benefit of Korean Patent Applications No. 10-2023-0167197, filed Nov. 27, 2023, and No. 10-2024-0071541, filed May 31, 2024, which are hereby incorporated by reference in their entireties into this application.

### BACKGROUND OF THE INVENTION

### 1. Technical Field

The present disclosure relates generally to 3D modeling technology, and more particularly to technology for transferring the style of a building model texture.

### 2. Description of the Related Art

Textures used in 3D building models are images created by capturing the exteriors of actual buildings. The texture of a building model represents the texture of the exterior of a building, visual effects appearing on the surface of the building, and components such as windows and doors of the building. Building models are used as base data for city model visualization such as a digital twin.

Particularly, in order to respond to a situation such as a weather condition set in a visualization environment created by a user or requirements for utilization platforms such as games and animations, a building model is required to provide textures having styles that match such a visualization environment.

For example, when a building model is used in a pixel game environment, a pixel-like building texture is required. In order to represent a rainy day, a building texture with a wet effect is required, and in a visualization environment that represents the passage of time, it is necessary to provide a texture with a style having an aged building exterior. In order to respond to demand given as the examples, building texture production methods have been proposed. One of representative methods of styling an exterior wall of a 3D building model is a method in which, after a light source is implemented in a 3D engine, a light filter is applied to a building texture using a light map that represents the area where a light effect by the light source is applied in the building model. Another method is to create categories by creating various styles and components, such as windows, walls, and columns of buildings, and to allow a user to select and combine styles for respective building components in the category.

3D building models are used in various applications, such as games, animations, a digital twin, and analysis using dynamic data. However, it is difficult to apply style transfer to existing building texture images to meet the needs of such applications. Due to the size and scale of buildings, it is difficult to directly capture and construct building texture style images that meet various needs. It is also difficult to use a style transfer network using existing Convolutional-Neural-Network- (CNN)-based deep-learning. This is because a 3D building model texture is in the format of an atlas in which images representing an exterior wall of a building are arranged and grouped in a compressed space. In other words, because this is an image format for optimizing a 3D rendering process and the number of draw calls in computer vision, rather than a facade format that well expresses components of a building, it is limited in being applied to style transfer using the existing method.

In order to solve this, it is necessary to develop a 3D building model texture style transfer pipeline that can be applied to existing style transfer deep-learning models.

Meanwhile, Korean Patent No. 10-2599170, titled “Real-time work producing system using style transfer and method thereof” discloses a system and method of creating a prior model for style transfer learning using style transfer by inputting a reference image dataset and a style image dataset, performing style transfer using the prior model, and providing a user with an image having a new style using the previously learned style image when receiving an image captured in real time.

### SUMMARY OF THE INVENTION

An object of the present disclosure is to provide a building model texture having a style that is not alien to the environment in which a user intends to use the texture by utilizing a preconstructed building model texture image and a reference image having the style desired by the user.

Another object of the present disclosure is to solve a problem in which an image of an existing building model texture cannot be applied to a style transfer network.

A further object of the present disclosure is to solve a problem of loss of building components during style transfer and a problem of existing style transfer training data construction.

Yet another object of the present disclosure is to reduce the necessity to construct training data for buildings having various sizes and to effectively use previously learned weights.

Still another object of the present disclosure is to enable style transfer desired by a user while preserving main components of a building during a style transfer process.

In order to accomplish the above objects, an apparatus for transferring a building model texture style according to an embodiment of the present disclosure includes one or more processors and memory for storing at least one program executed by the one or more processors, and the at least one program converts 3D building model geometry data and 3D building model texture information into a building model image after receiving the 3D building model geometry data and the 3D building model texture information, performs preprocessing for setting an area to which style transfer is to be applied by generating a mask image through segmentation into a window and a wall of the building model image and generating a floor gird area based on the segmentation into the window and the wall, performs style transfer of the building model image by applying a predefined user-style image to areas corresponding to the mask image and the floor grid area, and converts the building model image, the style of which is transferred, into 3D building model texture information.

Here, the mask image may correspond to an image representing areas of the window and the wall on which style transfer is to be performed in the building model image.

Here, the at least one program may generate the floor grid area based on a position relationship of the window and the wall depending on a result of the segmentation into the window and the wall in order to represent an area between respective floors of a building.

Here, the at least one program may generate the floor grid area based on minimum and maximum coordinate values forming a bounding box of a segmented window and the position relationship.

Here, the at least one program may transfer styles of the window and the wall according to constraints of the window and the wall using a prestored style transfer deep-learning network.

Here, the at least one program may perform the style transfer using a style transfer deep-learning network configured with ResNet.

Here, the at least one program may perform AdaIN normalization on a style image provided by the user and perform a concatenate operation on each ResNet block in order to add a style desired by the user as a constraint to the style transfer deep-learning network.

Also, in order to accomplish the above objects, a method for transferring a building model texture style, performed by an apparatus for transferring a building model texture style, according to an embodiment of the present disclosure includes converting 3D building model geometry data and 3D building model texture information into a building model image after receiving the 3D building model geometry data and the 3D building model texture information, performing preprocessing for setting an area to which style transfer is to be applied by generating a mask image through segmentation into a window and a wall of the building model image and generating a floor gird area based on the segmentation into the window and the wall, performing style transfer of the building model image by applying a predefined user-style image to areas corresponding to the mask image and the floor grid area, and converting the building model image, the style of which is transferred, into 3D building model texture information.

Here, the mask image may correspond to an image representing areas of a window and a wall on which style transfer is to be performed in the building model image.

Here, performing the preprocessing may comprise generating the floor grid area based on a position relationship of the window and the wall depending on a result of the segmentation into the window and the wall in order to represent an area between respective floors of a building.

Here, performing the preprocessing may comprise generating the floor grid area based on minimum and maximum coordinate values forming a bounding box of a segmented window and the position relationship.

Here, converting the building model image may comprise transferring styles of the window and the wall according to constraints of the window and the wall using a prestored style transfer deep-learning network.

Here, converting the building model image may comprise performing the style transfer using a style transfer deep-learning network configured with ResNet.

Here, converting the building model image may comprise performing AdaIN normalization on a style image provided by the user and performing a concatenate operation on each ResNet block in order to add a style desired by the user as a constraint to the style transfer deep-learning network.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an apparatus for transferring a building model texture style according to an embodiment of the present disclosure;

FIG. 2 is a view illustrating source data of a 3D building model according to an embodiment of the present disclosure;

FIG. 3 is a view illustrating an atlas image of 3D building model texture information according to an embodiment of the present disclosure;

FIG. 4 is a view illustrating a facade image acquired through 3D projection onto 2D and a polygon layout image according to an embodiment of the present disclosure;

FIGS. 5 and 6 are views illustrating a process of estimating a building floor grid through window-wall segmentation according to an embodiment of the present disclosure;

FIG. 7 is a view illustrating a process for transferring a building model texture style according to an embodiment of the present disclosure;

FIG. 8 is flowchart illustrating a method for transferring a building model texture style according to an embodiment of the present disclosure;

FIG. 9 is a flowchart illustrating in detail an example of the building-model-style-transfer preprocessing step illustrated in FIG. 8;

FIG. 10 is a flowchart illustrating in detail an example of the building model style transfer step illustrated in FIG. 8; and

FIG. 11 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

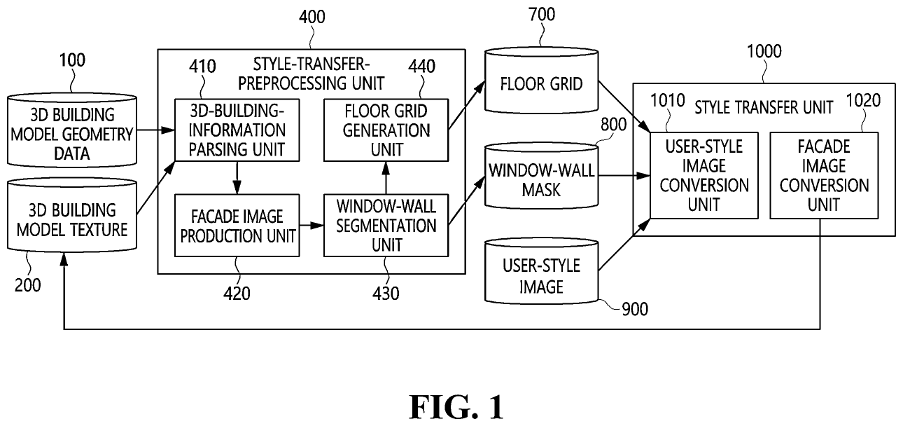

FIG. 1 is a block diagram illustrating an apparatus for transferring a building model texture style according to an embodiment of the present disclosure.

Referring to FIG. 1, the apparatus for transferring a building model texture style according to an embodiment of the present disclosure may include a 3D building model geometry data repository 100, a 3D building model texture repository 200, a style-transfer-preprocessing unit 400, a floor grid repository 700, a window-wall mask repository 800, a user-style image repository 900, and a style transfer unit 1000.

The 3D building model geometry data repository 100 may store indices of 3D vectors, UV, and polygons of a 3D building model.

The 3D building model texture repository 200 may store an atlas image corresponding to 3D building model texture information.

Here, the 3D building model texture information is an image in the form of an atlas used for a 3D building model, and may include the exterior texture and components of a building.

Here, the atlas image is an image format used for a 3D building model texture, and is an image of a group of triangles (a mesh) for optimizing draw calls.

Here, the atlas image may include the exterior texture and components of a building.

Polygons are triangles (mesh) that make up a 3D building model, and may include the texture and geometry data of the atlas image through UV mapping.

The style-transfer-preprocessing unit 400 receives 3D building model geometry data and 3D building model texture information and converts the same into a 2D building model image, and may perform preprocessing for transferring the style of the building model image.

Here, the style-transfer-preprocessing unit 400 may perform preprocessing for setting the area to which style transfer is to be applied by generating a mask image through segmentation into a window and a wall of the building model image and generating a floor grid area based on the segmentation into the window and the wall.

Here, the 2D building model image may correspond to a facade image.

Here, the facade image is an image of one face of a building captured from the front, and it clearly shows the components of the building and is a form of preconstructed building learning data.

Here, the style may correspond to a visual pattern that appears on the exterior wall of a building.

Here, the style may include changes in the exterior wall of a building, which result from the passage of time or environmental factors, pixelated or cartoon-style textures in a game environment, and the like.

For example, the style may include exterior wall patterns that appear when an exterior wall is deteriorated, such as cracks or smudges on the exterior wall, patterns such as sphagnum moss, moss, and water stains appearing due to a surrounding environment, and patterns such as a pixel style that appears in a particular built environment, such as a game or a cartoon.

Here, the style-transfer-preprocessing unit 400 may include a 3D-building-information parsing unit 410, a facade image production unit 420, a window-wall segmentation unit 430, and a floor grid generation unit 440.

The 3D-building-information parsing unit 410 may parse 3D building model geometry data and 3D building model texture information.

The 3D building model texture information may correspond to an atlas image.

The facade image production unit 420 may generate a facade image by projecting the 3D building model geometry data and the atlas images to a 2D building model image.

Here, the facade image production unit 420 may make arrangement in the form of a triangular mesh through UV mapping.

Here, the facade image production unit 420 may map the triangles in the atlas image in a 2D form to 3D coordinates using the triangular mesh form.

Because the mapped triangle include 3D point information, the orientation of the polygon may be found by finding a norm vector.

Here, the facade image production unit 420 may perform clustering in order to represent the face of a 3D building model to which the mapped triangle belongs based on the orientation of the polygon.

The reason for performing clustering is for converting each face of a building into a facade image that shows the components of the building.

Here, the facade image production unit 420 may perform clustering by mapping the triangle in the atlas image to 3D coordinates and finding the orientation of the polygon.

Here, the facade image production unit 420 may generate a facade image using the atlas image and indices of 3D vectors, UV, and polygons that make up the 3D building model of the 3D building model geometry data.

The window-wall segmentation unit 430 may perform segmentation into a window and a wall in the facade image in a deep-learning network.

Here, the window-wall segmentation unit 430 may generate a mask image based on the segmentation into the window and the wall.

The mask image is a black-and-white image for specifying a style transfer area, and is an image for clearly identifying the part, the style of which is to be transferred.

The floor grid generation unit 440 may generate a floor grid area based on the position relationship of the window and the walls depending on the result of segmentation into the window and the wall.

The floor grid area may correspond to an area representing each floor of a building, and may be estimated depending on the position relationship of the window and the wall.

Here, the floor grid generation unit 440 may generate a floor grid area based on minimum (min) and maximum (max) coordinate values forming the bounding box (bbox) of the segmented window and the position relationship.

Here, the floor grid generation unit 440 may compare Intersection over Union (IoU) between the floor information of a preconstructed LOD4 model and the estimated floor grid.

Here, the result value of the comparison is used as loss, whereby generation and learning of a floor grid may be performed using a simple F-CNN network.

The window-wall segmentation process and the floor grid generation process may change the target of style transfer to a wall and a window, which are the main components of a building, rather than applying the training data of the existing style transfer network to the entire building.

Accordingly, there is an effect of lowering the training data of the style transfer network to the level of a wall and a window, rather than training data for the entire building.

Also, through a task of generating a mask image, which is an image representing window and wall classification information, the target of style transfer is specified and converted in a style transfer process, whereby content loss may be reduced.

The style transfer unit 1000 may receive a user-style image, the mask image of the window and the wall, the floor grid area, and the 2D building model image, transfer a style in the 2D building model image, and convert the 2D building model image into 3D building model texture information.

Here, the style transfer unit 1000 may include a user-style image conversion unit 1010 and a facade image conversion unit 1020.

The user-style image conversion unit 1010 may receive a user-style image, the mask image of the window and the wall, the floor grid area, and the facade image and transfer the style of the facade image.

Here, the user-style image conversion unit 1010 normalizes the user-style image, thereby generating style transfer constraint features.

Here, the user-style image conversion unit 1010 may transfer the styles of the window and the wall according to constraints of the window and the wall using a prestored style transfer deep-learning network.

The style transfer deep-learning network is a deep-learning network that transfers a style by applying the learned style transfer features to an input image.

The facade image conversion unit 1020 may convert the facade image, the style of which is transferred, into an atlas image.

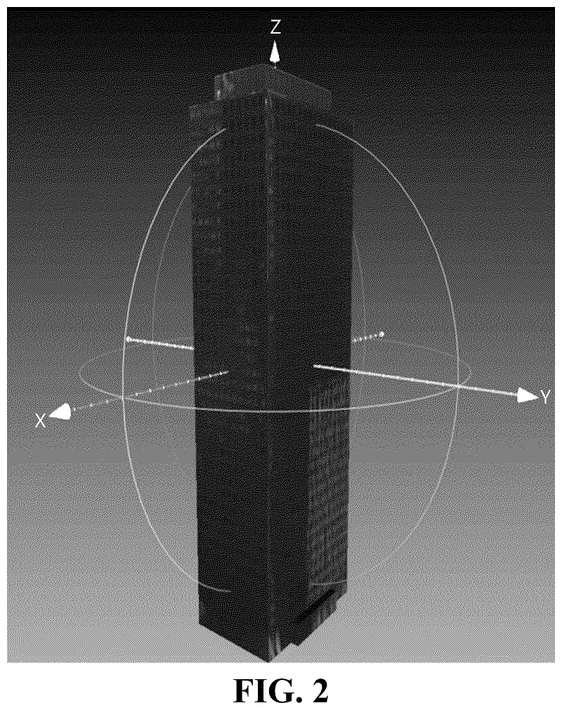

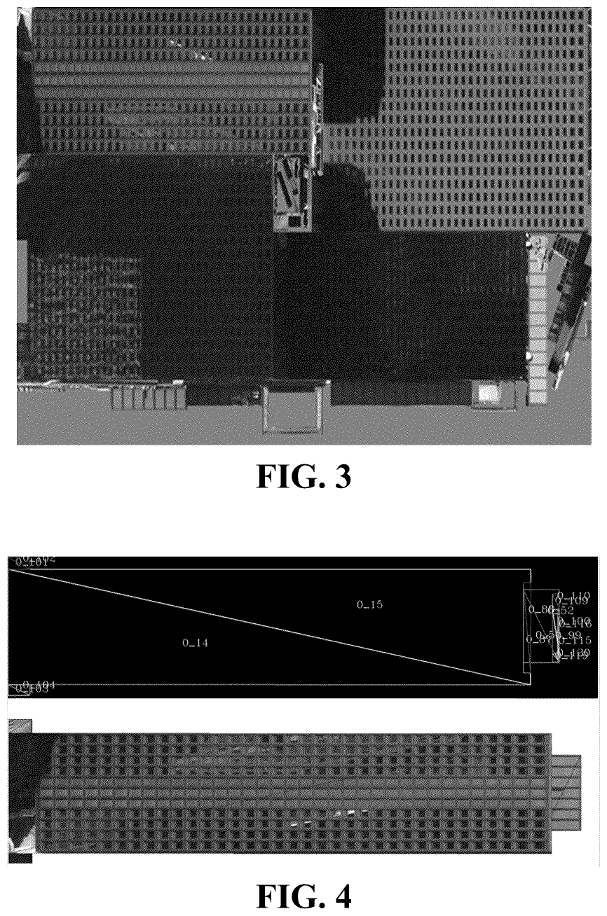

FIG. 2 is a view illustrating the source data of a 3D building model according to an embodiment of the present disclosure. FIG. 3 is a view illustrating an atlas image of 3D building model texture information according to an embodiment of the present disclosure.

Referring to FIG. 2, it can be seen that an example of a 3D building model is illustrated.

Referring to FIG. 3, it can be seen that an atlas image corresponding to 3D building model texture information is illustrated.

A 3D building model may be arranged in the form of a triangular mesh through UV mapping. Using this, the triangles in an atlas image in a 2D form may be mapped to 3D coordinates.

Because the mapped triangle includes 3D point information, the orientation of the polygon may be found by finding a norm vector.

The mapped triangles may be clustered depending on the face of the 3D building model to which the triangles belong based on the orientation of the polygon. The reason for performing clustering is to convert each face of the building into a facade image that shows the components of the building.

[Pseudocode 1]

```
Input: 3D building model vector(v[index]), UV(uv[index]), Face(face[index]), and Atlas 2D
image
Output: facade index of triangular mesh in atlas image, facade image draw using draw count
facade_clustring_dict = { }
polygon_norm_list = [ ]
model_center_point = center point of 3D building model
for polygon_idx in polygons_list: # polygons_list indicates polygon index
  # parse each 3D vertex of polygon
  p1 = vector[polygon_idx.p1]
  p2 = vector[polygon_idx.p2]
  p3 = vector[polygon_idx.p3]
  norm_vector_idx = # norm vector of polygon
  polygon_center_point = (p1 + p2 + p3) / 3 # polygon center point
  distance_center_to_polygon_center = abs(polygon_center_point - model_center_point) #
distance between polygon center and building center point
  polygon_norm_list.append((norm_vector_idx, distance_center_to_polygon_center))
cluster_list = DBScan(polygon_norm_list) # clustered list using DBScan based on norm vector
of each polygon
sorted_with_distance_polygon_list = sort(cluster_list) # generate draw order (in order of
distance between polygon and building center point from shortest to longest)
for polygon_index in cluster_list: # project 3D point onto 2D in consideration of clustered face
of building
  convert_3d_to_2d_coordinate = # value acquired by projecting 3D polygon coordinates
onto 2D
  draw(convert_3d_to_2d_coordinate, polygon_index) # generate facade texture using 2D
coordinate value
```

It can be seen that Pseudocode 1 shows a process of mapping triangles in the atlas image to 3D coordinates and performing clustering by finding the orientation of the polygons.

FIG. 4 is a view illustrating a facade image acquired through 3D projection onto 2D and a polygon layout image according to an embodiment of the present disclosure.

Referring to FIG. 4, it can be seen that a polygon layout image 10 representing polygon indices and positions and a facade image 20 acquired by projecting 3D data, in which uneven areas are processed, onto 2D using Pseudocode 1 are illustrated.

It can be seen that the facade image 20 is generated in consideration of the polygon layout image 10 that represents the distances from the center point of a building to the polygons.

Here, the facade image 20 is generated as a facade image for a building exterior in order to solve a problem in which an uneven area caused by the rooftop and ornament of a building is incorrectly viewed on the exterior of the facade.

The method of projecting the 3D coordinates of the polygon layout image 10 onto a 2D plane comprises registering the polygons that form each clustered face to x, y, and z axes using rotation matrices, identifying the axis with the lowest variability, removing the corresponding axis, and performing projection to the facade image 20.

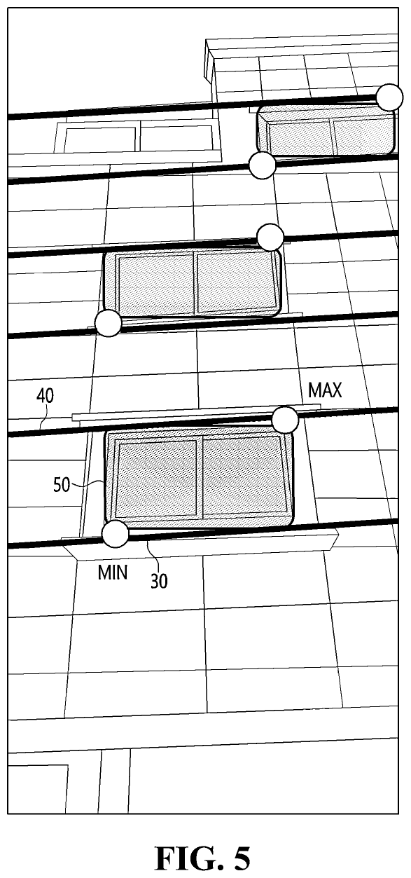

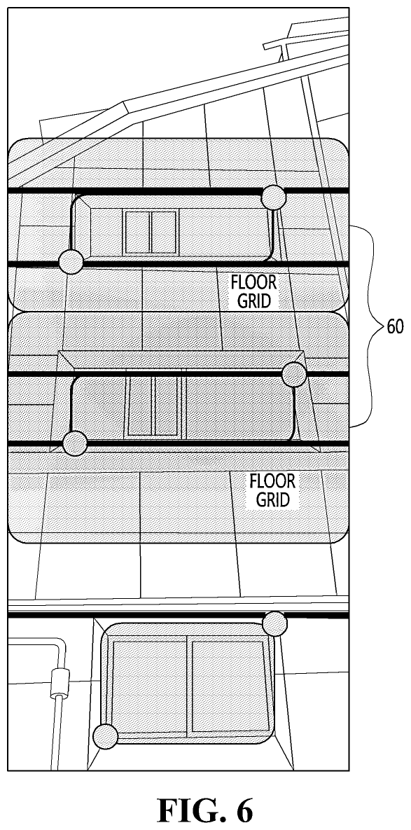

FIGS. 5 and 6 are views illustrating a process of estimating a building floor grid through window-wall segmentation according to an embodiment of the present disclosure.

Referring to FIG. 5, it can be seen that window-wall segmentation in the facade image of a building is illustrated.

By generating a facade image using an atlas image, window-wall segmentation enables training data required for 3D building model style transfer to be focused on style transfer for areas of windows and walls, rather than on construction of data for the entire building.

It can be seen that the window-wall segmentation generates minimum (min) and maximum (max) coordinate values 30 and 40 forming the bounding box (bbox) of the segmented window 50 and generates a mask image 50 corresponding to the bounding box that identifies the area of the window and the wall.

Window-wall segmentation reduces the burden of data collection required for a deep-learning network for window-wall classification and style transfer, and effective performance may be expected using a pretrained network.

Accordingly, window-wall segmentation reduces the necessity to collect massive data on the entire building and enables efficient use of training data that has already been accumulated.

Referring to FIG. 6, if the window and the wall are identified in the facade image of a building through window-wall segmentation, a floor area and floor information of the building may be inferred using the position relationship of the window.

The floor grid areas 60 may be estimated based on minimum (min) and maximum (max) coordinate values 30 and 40 forming the bounding box (bbox) of the segmented window 50 and the position relationship.

Here, IoU between the floor information of a preconstructed LOD4 model and the estimated floor grid may be compared.

Here, the result value of the comparison is used as loss, whereby generation and learning of a floor grid may be performed using a simple F-CNN network.

The trained network may be applied to a LOD3 model that does not include floor information.

When the mask image, which represents the position to which a style is to be applied, and the floor grid area of the building are acquired using the facade image of the building and window-wall segmentation, style transfer may be performed using the mask image and the floor grid area.

Style transfer may be applied to each of the wall and the window using a reference image corresponding to the style desired by a user.

Here, the style transfer may be performed for only the window and the wall, rather than adjusting the content loss in consideration of complex elements of the building.

For the style transfer of a 3D building model texture, a deep-learning network that does not have to pair data while maintaining the content of a building may be used.

Therefore, a style transfer deep-learning network configured with ResNet, rather than an encoder-decoder structure in the form of a bottleneck, may be used for style transfer.

Style transfer may comprise performing AdaIN normalization on the style image provided by a user and performing a concatenate operation on each ResNet block in order to add the style desired by the user as a constraint to the style transfer deep-learning network.

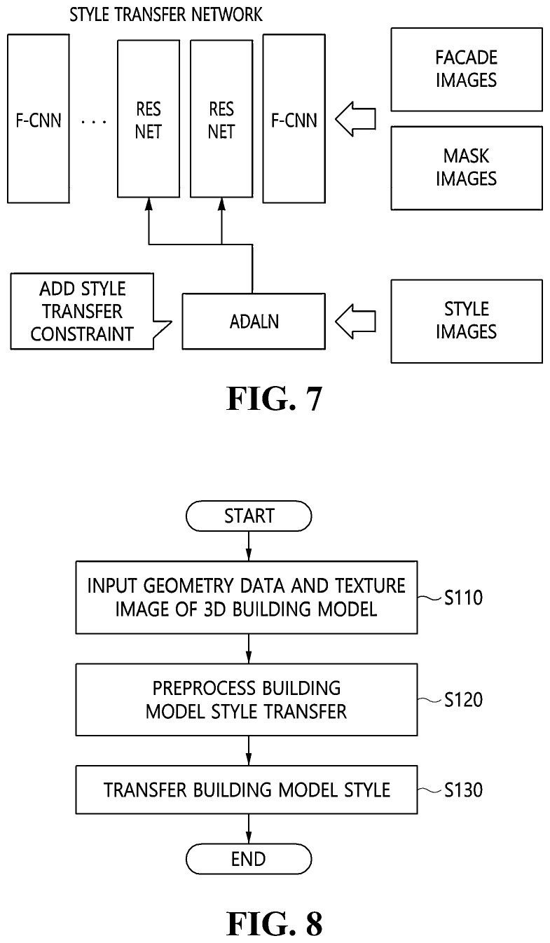

FIG. 7 is a view illustrating a building model texture style transfer process according to an embodiment of the present disclosure.

Referring to FIG. 7, in the building model texture style transfer process according to an embodiment of the present disclosure, the texture of a 3D building model is preprocessed into an atlas image using preconstructed training data and a trained network, and the style may be transferred to suit the requirements of a user.

The building model texture style transfer method may relieve the difficulty of constructing training data according to the scale of a building and enable efficient style transfer for a complex building model to be performed.

Particularly, the building model texture style transfer method may respond to various demand scenarios of 3D building models and contribute to reducing the time and cost of style texture work that used to be manually performed.

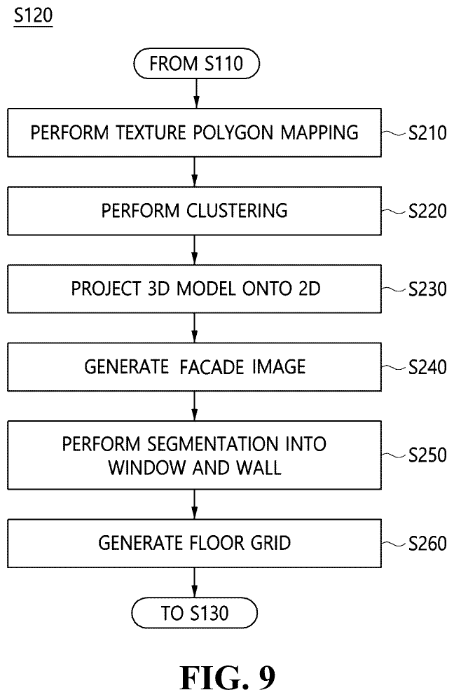

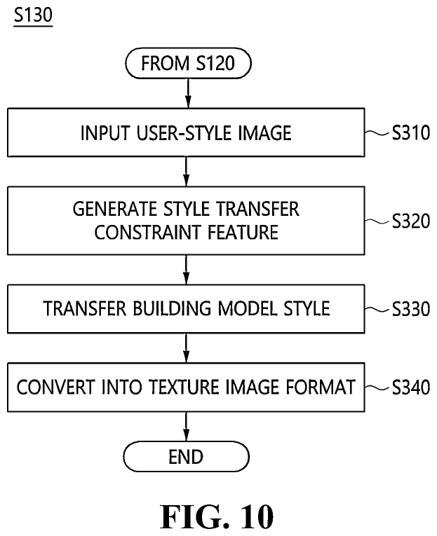

FIG. 8 is a flowchart illustrating a method for transferring a building model texture style according to an embodiment of the present disclosure. FIG. 9 is flowchart illustrating in detail an example of the building-model-style-transfer preprocessing step illustrated in FIG. 8. FIG. 10 is a flowchart illustrating in detail an example of the building model style transfer step illustrated in FIG. 8.

Referring to FIG. 8, in the building model texture style transfer method according to an embodiment of the present disclosure, 3D building model geometry data and 3D building model texture information may be input at step S110.

That is, at step S110, the 3D building model geometry data and the 3D building model texture information may be input and converted into a 2D building model image.

Also, in the building model texture style transfer method according to an embodiment of the present disclosure, preprocessing for transferring the style of the building model image may be performed at step S120.

That is, at step S120, a mask image is generated by performing segmentation into a window and a wall of the building model image, and a floor grid area is generated based on the segmentation into the window and the wall, whereby preprocessing for setting the area to which style transfer is to be applied may be performed.

Here, the building model image may correspond to a facade image.

Here, the facade image is an image of one face of a building captured from the front, and it clearly shows the components of the building and is a form of preconstructed building learning data.

Here, the style may correspond to a visual pattern that appears on the exterior wall of a building.

Here, the style may include changes in the exterior wall of a building, which result from the passage of time or environmental factors, pixelated or cartoon-style textures in a game environment, and the like.

For example, the style may include exterior wall patterns that appear when an exterior wall is deteriorated, such as cracks or smudges on the exterior wall, patterns such as sphagnum moss, moss, and water stains appearing due to a surrounding environment, and patterns such as a pixel style that appears in a particular built environment, such as a game or a cartoon.

Referring to FIG. 9, at step S120, texture polygon mapping may be performed at step S210.

That is, at step S210, the 3D building model geometry data and the 3D building model texture information may be parsed.

Here, at step S210, arrangement in the form of a triangular mesh may be made through UV mapping.

Here, at step S210, triangles in an atlas image in a 2D form may be mapped to 3D coordinates using the triangular mesh form.

Because the mapped triangle includes 3D point information, the orientation of the polygon may be found by finding a norm vector.

The 3D building model texture information may correspond to the atlas image.

Also, at step S120, clustering may be performed at step S220.

That is, at step S220, clustering may be performed in order to indicate the face of the 3D building model to which the mapped triangle belongs based on the orientation of the polygon.

The reason for performing clustering is for converting each face of a building into a facade image that shows the components of the building.

Also, at step S120, the 3D building model texture may be projected to the 2D building model image at step S230.

Also, at step S120, a facade image may be generated at step S240.

That is, at step S240, a facade image may be generated by projecting the 3D building model geometry data and the atlas image to the 2D building model image.

Here, at step S240, a facade image may be generated using the atlas image and indices of 3D vectors, UV, and polygons that make up the 3D building model of the 3D building model geometry data.

Also, at step S120, window-wall segmentation may be performed at step S250.

That is, at step S250, segmentation into a window and a wall in the facade image may be performed in a deep-learning network.

Here, at step S250, a mask image may be generated based on the segmentation into the window and the wall.

The mask image is a black-and-white image for specifying a style transfer area, and is an image for clearly identifying the part, the style of which is to be transferred.

Also, at step S120, a floor grid area may be generated at step S260.

That is, at step S260, a floor grid area may be generated based on the position relationship of the window and the wall depending on the result of the segmentation into the window and the wall.

The floor grid area may correspond to an area representing each floor of a building, and may be estimated depending on the position relationship of the window and the wall.

Here, at step S260, the floor grid area may be generated based on minimum (min) and maximum (max) coordinate values forming the bounding box (bbox) of the segmented window and the position relationship.

Here, at step S260, IoU between the floor information of a preconstructed LOD4 model and the estimated floor grid may be compared.

Here, the result value of the comparison is used as loss, whereby generation and learning of a floor grid may be performed using a simple F-CNN network.

The window-wall segmentation process and the floor grid generation process may change the target of style transfer to a wall and a window, which are the main components of a building, rather than applying the training data of the existing style transfer network to the entire building.

Accordingly, there is an effect of lowering the training data of the style transfer network to the level of a wall and a window, rather than training data for the entire building.

Also, through a task of generating a mask image, which is an image representing window and wall classification information, the target of style transfer is specified and converted in the style transfer process, whereby content loss may be reduced.

Also, in the building model texture style transfer method according to an embodiment of the present disclosure, style transfer of the building model may be performed at step S130.

That is, at step S130, a user-style image, the mask image of the window and the wall, the floor grid area, and the 2D building model image are input, the style of the 2D building model image is transferred, and the 2D building model image may be converted into 3D building model texture information.

Referring to FIG. 10, at step S130, the user-style image may be input at step S310.

That is, at step S310, the user-style image, the mask image of the window and the wall, the floor grid area, and the 2D building model image may be input.

Also, at steps S130, style transfer constraint features may be generated at step S320.

That is, at step S320, the user-style image is normalized, whereby style transfer constraint features may be generated.

Also, at step S130, building model style transfer may be performed at step S330.

That is, at step S330, the style of the facade image may be transferred by receiving the user-style image, the mask image of the window and the wall, the floor grid area, and the facade image.

Here, at step S330, the styles of the window and the wall may be transferred according to the constraints of the window and the wall using a prestored style transfer deep-learning network.

The style transfer deep-learning network is a deep-learning network that transfers a style by applying learned style transfer features to an input image.

Also, at step S130, the building model image, the style of which is transferred, may be converted into 3D building model texture information at step S340.

That is, at step S340, the facade image, the style of which is transferred, may be converted into an atlas image.

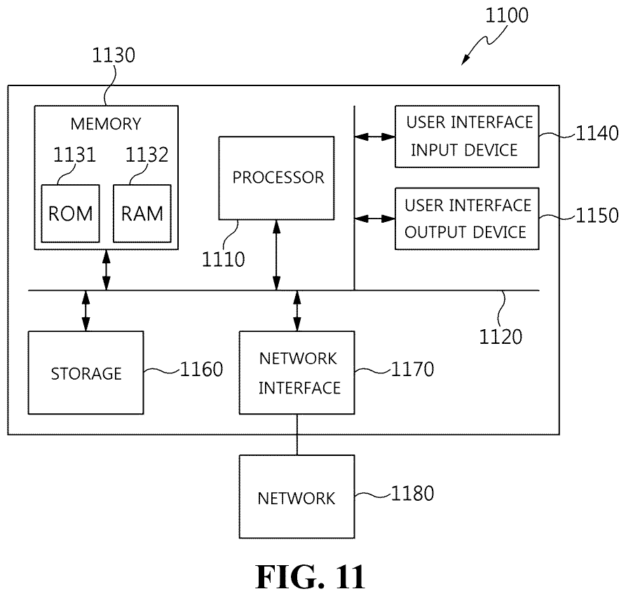

FIG. 11 is a view illustrating a computer system according to an embodiment of the present disclosure.

Referring to FIG. 11, the apparatus for transferring a building model texture style according to an embodiment of the present disclosure may be implemented in a computer system 1100 including a computer-readable recording medium. As illustrated in FIG. 11, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for transferring a building model texture style according to an embodiment of the present disclosure includes one or more processors 1110 and memory 1130 for storing at least one program executed by the one or more processors 1110, and the at least one program converts 3D building model geometry data and 3D building model texture information into a building model image after receiving the 3D building model geometry data and the 3D building model texture information, performs preprocessing for setting the area to which style transfer is to be applied by generating a mask image through segmentation into a window and a wall of the building model image and generating a floor grid area based on the segmentation into the window and the wall, performs style transfer of the building model image by applying a predefined user-style image to areas corresponding to the mask image and the floor grid area, and converts the building model image, the style of which is transferred, into 3D building model texture information.

Here, the mask image may correspond to an image representing the areas of the window and the wall on which style transfer is to be performed in the building model image.

Here, the at least one program may generate the floor grid area based on the position relationship of the window and the wall depending on the result of the segmentation into the window and the wall in order to represent an area between respective floors of a building.

Here, the at least one program may generate the floor grid area based on minimum and maximum coordinate values forming the bounding box of the segmented window and the position relationship.

Here, the at least one program may transfer the styles of the window and the wall according to the constraints of the window and the wall using a prestored style transfer deep-learning network.

Here, the at least one program may perform the style transfer using a style transfer deep-learning network configured with ResNet.

Here, the at least one program may perform AdaIN normalization on the style image provided by the user and perform a concatenate operation on each ResNet block in order to add the style desired by the user as a constraint to the style transfer deep-learning network.

The present disclosure may provide a building model texture having a style that is not alien to the environment in which a user intends to use the texture by utilizing a preconstructed building model texture image and a reference image having the style desired by the user.

Also, the present disclosure may solve a problem in which an image of an existing building model texture cannot be applied to a style transfer network.

Also, the present disclosure may solve a problem of loss of building components during style transfer and a problem of existing style transfer training data construction.

Also, the present disclosure may reduce the necessity to construct training data for buildings having various sizes and may effectively use previously learned weights.

Also, the present disclosure may enable style transfer desired by a user while preserving main components of a building during a style transfer process.

As described above, the apparatus and method for transferring a building model texture style according to the present disclosure are not limitedly applied to the configurations and operations of the above-described embodiments, but all or some of the embodiments may be selectively combined and configured, so the embodiments may be modified in various ways.

What is claimed is:

1. An apparatus for transferring a building model texture style, comprising:
one or more processors; and
memory for storing at least one program executed by the one or more processors,
wherein the at least one program
converts 3D building model geometry data and 3D building model texture information into a building model image after receiving the 3D building model geometry data and the 3D building model texture information,
performs preprocessing for setting an area to which style transfer is to be applied by generating a mask image through segmentation into a window and a wall of the building model image and generating a floor gird area based on the segmentation into the window and the wall,
performs style transfer of the building model image by applying a predefined user-style image to areas corresponding to the mask image and the floor grid area, and
converts the building model image, a style of which is transferred, into 3D building model texture information.

2. The apparatus of claim 1, wherein the mask image corresponds to an image representing areas of the window and the wall on which style transfer is to be performed in the building model image.

3. The apparatus of claim 2, wherein the at least one program generates the floor grid area based on a position relationship of the window and the wall depending on a result of the segmentation into the window and the wall in order to represent an area between respective floors of a building.

4. The apparatus of claim 3, wherein the at least one program generates the floor grid area based on minimum and maximum coordinate values forming a bounding box of a segmented window and the position relationship.

5. The apparatus of claim 1, wherein the at least one program transfers styles of the window and the wall according to constraints of the window and the wall using a prestored style transfer deep-learning network.

6. The apparatus of claim 5, wherein the at least one program performs the style transfer using a style transfer deep-learning network configured with ResNet.

7. The apparatus of claim 6, wherein the at least one program performs AdaIN normalization on a style image provided by the user and performs a concatenate operation on each ResNet block in order to add a style desired by the user as a constraint to the style transfer deep-learning network.

8. A method for transferring a building model texture style, performed by an apparatus for transferring a building model texture style, comprising:
converting 3D building model geometry data and 3D building model texture information into a building model image after receiving the 3D building model geometry data and the 3D building model texture information,
performing preprocessing for setting an area to which style transfer is to be applied by generating a mask image through segmentation into a window and a wall of the building model image and generating a floor gird area based on the segmentation into the window and the wall, and
performing style transfer of the building model image by applying a predefined user-style image to areas corresponding to the mask image and the floor grid area and converting the building model image, a style of which is transferred, into 3D building model texture information.

9. The method of claim 8, wherein the mask image corresponds to an image representing areas of the window and the wall on which style transfer is to be performed in the building model image.

10. The method of claim 9, wherein performing the preprocessing comprises generating the floor grid area based on a position relationship of the window and the wall depending on a result of the segmentation into the window and the wall in order to represent an area between respective floors of a building.

11. The method of claim 10, wherein performing the preprocessing comprises generating the floor grid area based on minimum and maximum coordinate values forming a bounding box of a segmented window and the position relationship.

12. The method of claim 8, wherein converting the building model image comprises transferring styles of the window and the wall according to constraints of the window and the wall using a prestored style transfer deep-learning network.

13. The method of claim 12, wherein converting the building model image comprises performing the style transfer using a style transfer deep-learning network configured with ResNet.

14. The method of claim 13, wherein converting the building model image comprises performing AdaIN normalization on a style image provided by the user and performing a concatenate operation on each ResNet block in order to add a style desired by the user as a constraint to the style transfer deep-learning network.
